(19) United States
(12) Patent Application Publication
(10) Pub. No.: US 2011/0283539 A1
(43) Pub. Date: Nov. 24, 2011

(54) MANUAL RAZOR WITH ROTATABLE BLADE HEAD

(75) Inventor: Richard Wayne Bryan, Auckland (NZ)

(73) Assignee: CLOSE CUT CO LIMITED, Manukau (NZ)

(21) Appl. No.: 13/129,814

(22) PCT Filed: Nov. 12, 2009
(86) PCT No.: PCT/NZ2009/000248

§ 371 Date: Aug. 2, 2011

(30) Foreign Application Priority Data
Nov. 13, 2008 (NZ) 572832

(51) Int. Cl. B26B 21/22; B26B 21/24

(52) U.S. Cl. 30/40.2; 30/50

(57) ABSTRACT

A manual razor comprising an elongate handle and a disposable razor blade head removeably located substantially at one end of said handle. The razor blade head includes a rotatable head body and a plurality of elongate blades mounted from said head body. Both together are rotational about an axis parallel to the elongate direction of the blades. The blades can be sequentially presented to present at least one of said blades in an operative manner for shaving. An adjuster is provided that is operatively engaged with said head body and includes an input actuator located by said handle body to allow a digit of a user to actuate the rotation of the head body and plurality of elongate blades.

### FIELD OF INVENTION

The present invention relates to manual razors.

### BACKGROUND

A rotary razor is an alternative to the common disposable razor. Rotary razors commonly have a rotatable razor blade head. The razor blade heads may have multiple faces with one or more blades located on each face. At any time one face is exposed to present one or more blades for use. When the user has used the razor blade(s) located on one face of the rotatable razor blade head they may then rotate the head so that new razor blade(s) are exposed for use. After all of the razor blades have been used the razor may be discarded, or the blade head may be replaced. Such a system is described, for example in U.S. Pat. No. 3,722,091.

U.S. Pat. No. 372,091 describes a rotary razor having a blade head that is hexagonal in cross section. The blade head has six blades, each blade extending from one side of the hexagonal head. The head had a control knob at each end. After a blade has been used for a period of time, and the user desires to shave with a new blade, the user may turn the control knobs at each end which will rotate the head to expose a new blade.

A similar device is described in U.S. Pat. No. 3,430,341 in which a dial at one end of the blade head is turned in order to rotate the head, to expose a new blade. The dial has a series of numerals on it which aid in identifying which of the blades has been used.

Rotary razors that rely on manual adjustment of the blade head may suffer from inaccuracies in the positioning of the head. This is because the head may not be able to index accurately to present the razor blades properly in each location. A more accurate system would be desirable, to ensure the razor blade head may index to locate the razor blades more precisely for use.

Furthermore, adjustment of the blade head on devices such as the ones described above may require two hands, one to hold the razor and the other to rotate the blade head. The ability to adjust the shaver head using only one hand is desirable.

In this specification, where references has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art of form part of the common general knowledge in the art.

Accordingly, it is an object of the present invention to provide a razor with a rotatable blade head which overcomes or at least ameliorates some of the abovementioned disadvantages or which at least provides the public with a useful choice.

### BRIEF DESCRIPTION OF THE INVENTION

In a first aspect the present invention consists in a manual razor comprising:

an elongate handle body,

a disposable razor blade head removably located substantially at one end of said handle body, said razor blade head comprising a rotatable head body and a plurality of elongate blades mounted from said head body in a manner to be rotational about and axis parallel to the elongate direction of the blades, wherein blades can be sequentially presented to present at least one of said blades in an operative manner for shaving,

an adjuster operatively engaged with said head body and including an input actuator located by said handle body to allow a digit of a user to actuate the rotation of the head body and plurality of elongate blades.

Preferably said input actuator is rotatably mounted relative said handle body.

Preferably said adjuster includes a gear train, wherein said gear train can transfer rotational torque (preferably in a mechanical advantages manner) from said input actuator to said head body.

Preferably said input actuator is located substantially at the centre of a rotatable shaft mounted by said handle body.

Preferably said head body includes an axle.

Preferably said gear train comprises:

a primary gear located substantially by said rotatable shaft,

a final gear located by said axle,

a intermediate gear located between said primary gear and said final gear, said intermediate gear adapted to transfer rotation torque (preferably in a mechanical advantaged manner) from said primary gear to said final gear.

Preferably said primary gear is located substantially at an end of said rotatable shaft.

Preferably said final gear is located substantially at an end of said axle, and rigidly fixed to said axle

Preferably said intermediate gear comprises a receiving gear wheel to receive said rotational torque from said primary gear, and a transmitting gear wheel to transmit said rotational torque to said final gear,

wherein said receiving gear wheel and said transmitting gear wheel are rotationally fixed relative to one another.

Preferably said receiving gear wheel and said transmitting gear wheel are connected together via an axle.

Preferably said intermediate gear is manufactured as a unitary item.

Preferably said input actuator is a substantially cylindrical member.

Preferably said input actuator can be actuated by a digit of a user.

Preferably said razor blade head is coupled to said handle body by a retention means.

Preferably said retention means consists of at least one head retainer link.

Preferably said at least one head retainer link is located substantially at one end of said handle body.

Preferably said head retainer link can engage with a complementary part of said razor blade head.

Preferably said head retainer link can engage in a snap-lock relationship with said razor blade head.

Preferably a button is provided to enable said razor blade head to be released from said retainer link.

Preferably said button causes said retainer link to deflect to allow said retainer link to disengage with said complementary part of said razor blade head.

Preferably said razor blade head includes a ratchet mechanism provided to ensure said head body can only rotate in one direction about said rotational axis.

Preferably said ratchet mechanism includes a pawl in engagement with a gear, said gear being rigidly fixed to said axle,

wherein said pawl constrains said gear to one direction of rotation.

Preferably said ratchet mechanism includes a pawl in engagement with said final gear wheel, said final gear wheel being rigidly fixed to said axle,

wherein said pawl constrains said final gear wheel to one direction of rotation.

Preferably said head body has at least three face sides, wherein at least one of said elongate blades are mounted to each said face side.

Preferably a plurality of said elongate blades are mounted to each said face side of said head body.

Preferably said disposable razor blade head includes a housing that mounts and substantially houses said head body.

Preferably the head body comprises:
an axle,
at least two spaced apart hubs extending from said axle,
wherein each hub mounts said plurality of elongate blades such that the blades are mounted in a manner to each extend, in their elongate direction, parallel to each other and parallel to the axle.

Preferably the blades do not contact the central axle and are positioned spaced away from the central axle to facilitate a cleaning of the blades by water that can circulate between the blades and the axle.

Preferably the blades are supported by each of the hubs only.

Preferably the blades are mounted to not contact each other.

Preferably the blades are of a sheet metal.

Preferably the axle comprises of multiple parts each part including one of the hubs, wherein each axle part can engage with (and preferably to) the other axle parts to form a central axle assembly.

Preferably each blade includes a straight cutting edge parallel to the elongate direction.

In a second aspect the present invention consists in a disposable razor blade head for removable engagement to an elongate handle that includes an input actuator, said razor blade head comprising
a head body rotatable relative to said handle,
a plurality of elongate blades mounted from said head body in a manner to be rotational with said head body about and axis parallel to the elongate direction of the blades, wherein blades can be sequentially presented to present at least one of said blades in an operative manner for shaving,
a gear operatively engaged with said head body and capable of becoming operatively engaged with said input actuator that allows a digit of a user to actuate the rotation of the head body and plurality of elongate blades.

Preferably said head body includes an axle.

Preferably said gear is located by said axle, and is presented to be able to operatively engage with said input actuator.

Preferably said gear is located substantially at an end of said axle, and rigidly fixed to said axle

Preferably said razor blade head includes a mount that is able to releasably couple to said handle by a retention means.

Preferably said retention means consists of at least one head retainer link.

Preferably said at least one head retainer link is located substantially at one end of said handle.

Preferably said mount can engage with a complementary part of the head retainer link.

Preferably said mount can engage in a snap-lock relationship with said head retainer link.

Preferably a button is provided to enable said razor blade head to be released from said retainer link.

Preferably said button causes said retainer link to deflect to allow said retainer link to disengage with said mount of said razor blade head.

Preferably said razor blade head includes a ratchet mechanism provided to ensure said head body can only rotate in one direction about said rotational axis.

Preferably said ratchet mechanism includes a pawl in engagement with a gear, said gear being rigidly fixed to said axle,

wherein said pawl constrains said gear to one direction of rotation.

Preferably said ratchet mechanism includes a pawl in engagement with said gear, said gear being rigidly fixed to said axle,

wherein said pawl constrains said gear to one direction of rotation.

Preferably said head body has at least three face sides, wherein at least one of said elongate blades are mounted to each said face side.

Preferably a plurality of said elongate blades are mounted to each said face side of said head body.

Preferably said disposable razor blade head includes a housing that mounts and substantially houses said head body.

Preferably the head body comprises:
an axle,
at least two spaced apart hubs extending from said axle,
wherein each hub mounts said plurality of elongate blades such that the blades are mounted in a manner to each extend, in their elongate direction, parallel to each other and parallel to the axle.

Preferably the blades do not contact the central axle and are positioned spaced away from the central axle to facilitate a cleaning of the blades by water that can circulate between the blades and the axle.

Preferably the blades are supported by each of the hubs only.

Preferably the blades are mounted to not contact each other.

Preferably the blades are of a sheet metal.

Preferably the axle comprises of multiple parts each part including one of the hubs, wherein each axle part can engage with (and preferably to) the other axle parts to form a central axle assembly.

Preferably each blade includes a straight cutting edge parallel to the elongate direction.

In a further aspect the present invention consists in a manual razor as herein described with reference to any one or more of the accompanying representations.

In a further aspect the present invention consists in a disposable razor blade head as herein described with reference to any one or more of the accompanying representations

Other aspects of the invention may become apparent from the following description which is given by way of example only and with reference to the accompanying drawings.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features, prefaced by that term in each statement, all need to be present but other features can also be present. Related terms such as “comprise” and “comprised” are to be interpreted in the same manner.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

### BRIEF DESCRIPTION OF THE DRAWINGS

The invention will now be described by way of example only and with reference to the drawings in which:

FIG. 1 is an exploded perspective view of a razor with a rotatable blade head,

FIG. 2 is an exploded side view of a razor with a rotatable blade head,

FIG. 3 is a close up side view of a razor with a rotatable blade head,

FIG. 4 is a side view of a five sided blade head body,

FIG. 5 is an end view of a five sided blade head body,

FIG. 6 is an end view of a blade head body showing a ratchet mechanism,

FIG. 7 is a view of an alternative gear train,

FIG. 8 is a front perspective view of the gear train of FIG. 7, and

FIG. 9 is a rear perspective view of the gear train of FIG. 7,

FIG. 10 is a perspective view of a shaver head,

FIG. 11 is another perspective view of a shaver head,

FIG. 12 is an exploded assembly view of a shaver head showing the parts that make up the head and the blades to be located on the head,

FIG. 13 is a side view of the exploded assembly view of FIG. 12,

FIG. 14 is a side view of the shaver head of FIG. 1 showing the locations of the cross sections A-A and B-B,

FIG. 15 is a cross-sectional view through A-A,

FIG. 16 is an end view of the shaver head of FIG. 10,

FIG. 17 is a cross-sectional view through B-B,

FIG. 18 is an end view of a shaver head that has four sides with blades mounted thereon,

FIG. 19 is an end view of a shaver head that has five sides with blades mounted thereon,

FIG. 20 is an end view of a shaver head that has six sides with blades mounted thereon,

FIG. 21 is an end view of a shaver head that has seven sides with blades mounted thereon,

FIG. 22 is an end view of a shaver head that has eight sides with blades mounted thereon,

FIG. 23 is an end view of a shaver head that has nine sides with blades mounted thereon,

FIG. 24 is an end view of a shaver head that has ten sides with blades mounted thereon,

FIG. 25 is an end view of a shaver head that has eleven sides with blades mounted thereon,

FIG. 26 is an end view of a shaver head that has twelve sides with blades mounted thereon, and

FIG. 27 is an end view of a round shaver head.

### DETAILED DESCRIPTION OF THE INVENTION

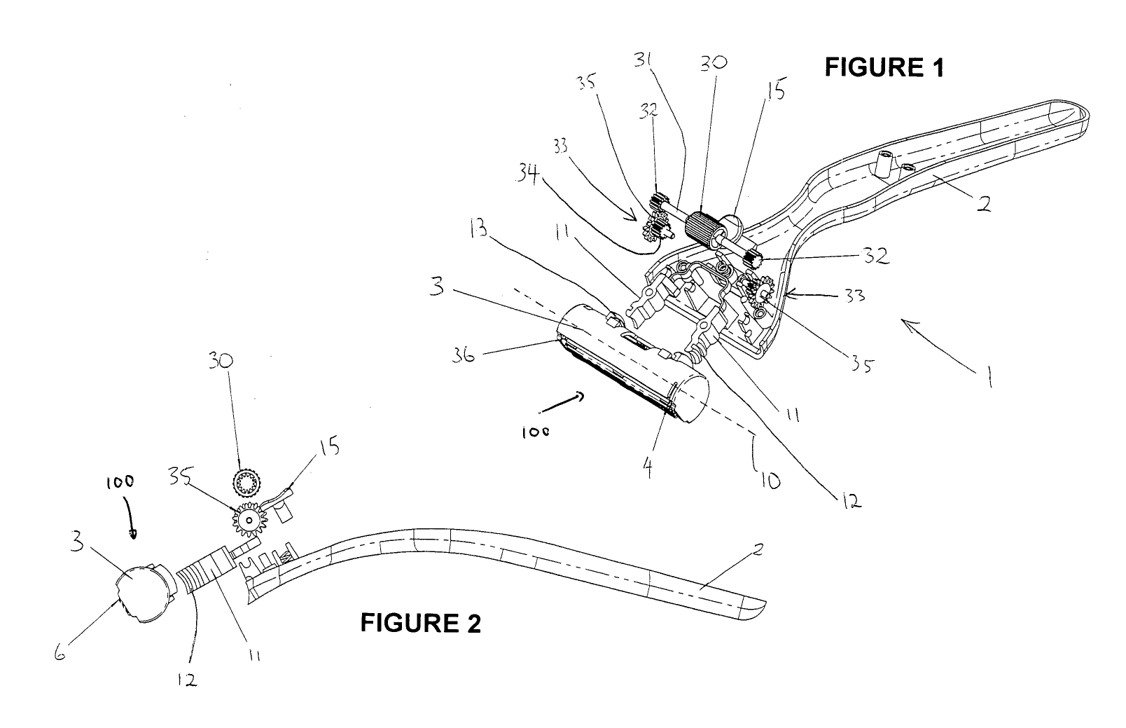

With reference to FIG. 1 there is shown a rotary shaver 1. The rotary shaver 1 has a handle 2 which is preferably of an elongate shape as shown. Alternatively, the handle 2 may be of any shape. The handle 2 is preferably injection moulded plastic. Alternatively, the handle 2 may be manufactured by any other suitable manufacturing process.

A razor blade head 100 may be removeably engaged to the handle 2. The head 100 includes a razor blade head housing 3 located at one end of said handle 2 as shown. The razor blade head housing 3 is preferably plastic and manufactured by an injection moulding process. Alternatively the razor blade head housing may be manufactured in any other suitable way.

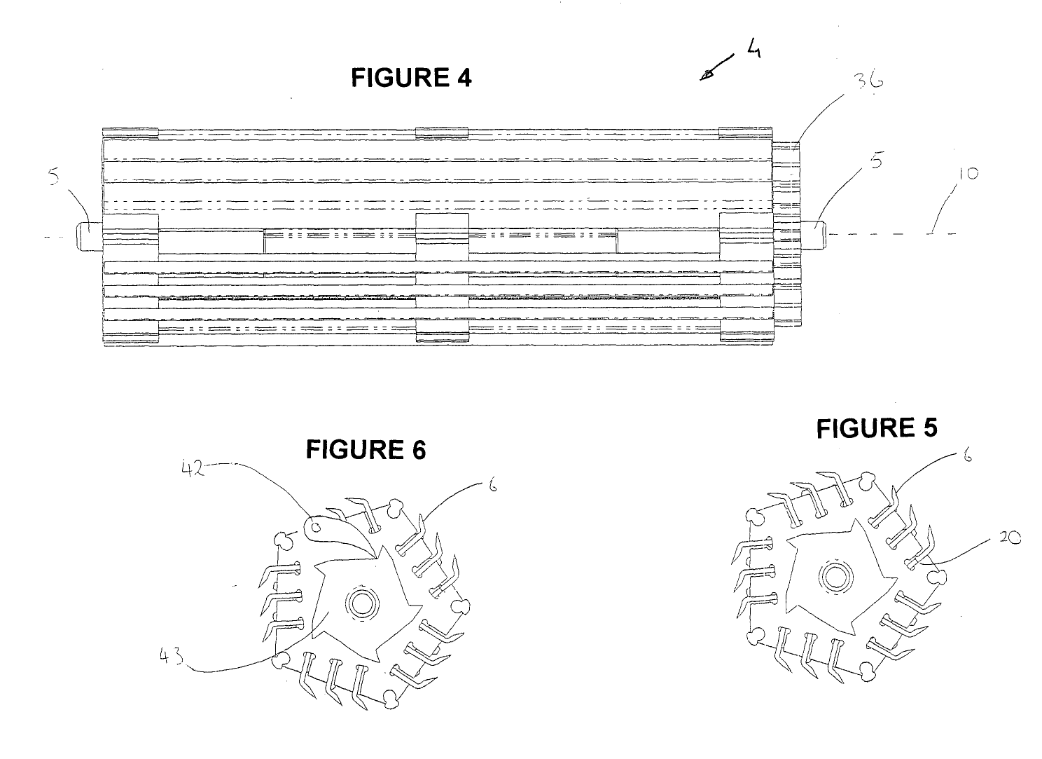

The razor blade head housing 3 houses a head body 4. An example of a head body 4 is shown in FIG. 4 and FIG. 5. FIGS. 4 and 5 show a five sided head body 4. Alternatively the head body 4 may have any number of face sides or may be round. For example, the head body 4 may have three, four, five, six, seven, eight, nine, ten, eleven, twelve or any other number of face sides.

At least one razor blade 6 may be located on each side of the head body 4. As shown in FIG. 5 there may be three razor blades 6 located on each of the five face sides of the head body 4. Alternatively any number of razor blades 6 may be located on a side of the head body 4. For example, the head body may have one, two, three, four, five or any other number of razor blades 6 located thereon.

The head body 4 may be rotatable relative to and predominantly inside the head housing 3. Preferably the head body 4 has a axle 5 as shown in FIG. 4, to allow the head body 4 to rotate relative the head housing 3. The axle 5 may engage with a complementary recess at each end of the razor blade head housing 3 to allow the head body to rotate about its longitudinal axis 10.

The head 100 may engage with the retainer links 11. The retainer links may extend from the handle 2 as shown in FIG. 1. The retainer links may have an engaging portion 12 which may engage with a complementary engaging portion 13 of the razor blade head housing. The engaging portions 12 and 13 are preferably of the “snap-lock” type, or alternatively may engage in any other suitable way.

A button 15 may be located on the handle 2. The button 15 may be operatively engaged with the retainer links 11. Therefore, if a user was to press the button the retainer links may “pinch” together to allow disengagement with the engaging portions 13. This will allow the razor blade head housing 3 to be released. The head 100 may be replaced at any time by a new head. For example, if the blades 6 on each face of the head body 4 have become blunt from use, the entire head 100 may be replaced with a new one. Alternatively, just the razor blade head body 4 may be replaced, by inserting a new head body 4 into the razor blade head housing 3.

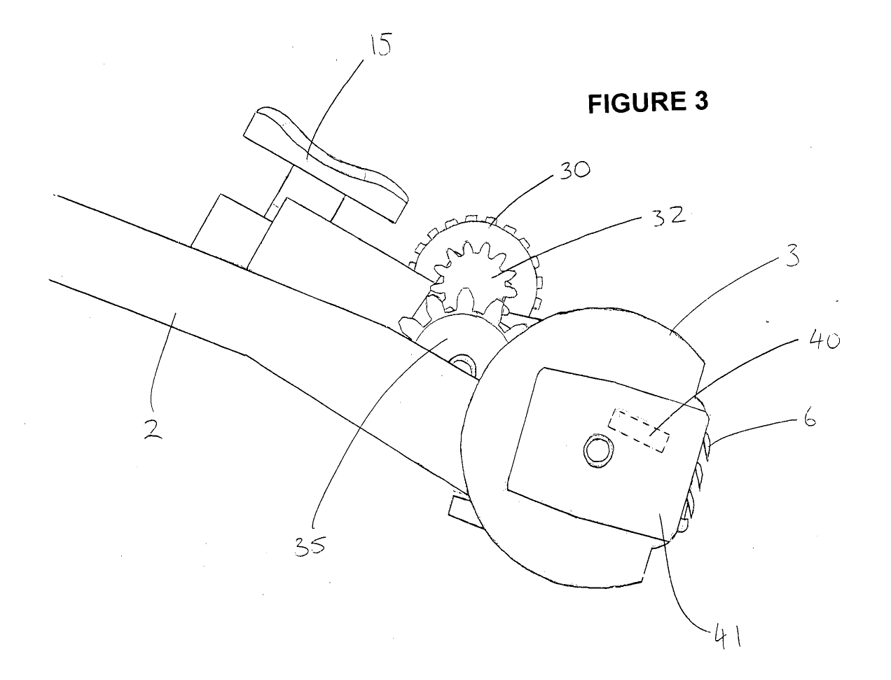

As shown on FIG. 3, a series of blades 6 are presented for use in shaving. The blades 6 shown on FIG. 3 are the blades 6 located on one side of the head body 4. The head body 4 may have any number of face sides, and there may be any number of blades 6 located on each side of the head body 4. The blades 6 are mounted parallel with the longitudinal axis 10 of the head body 4. As shown in FIG. 5 each blade 6 may be recessed into a slot 20. The slots 20 ensure the blades 6 are rigidly fixed to the head body 4. The blades 6 may be press fitted into the slots 20. Alternatively, any other method of securing the blades 6 to the head body 4 may be used.

When the blades 6 on one side of the blade head body 4 have been used sufficiently such that the user desires unused blades, the user may effect rotation of the head body 4 to expose a new face of the head body 4, and thus an unused set of blades 6 for shaving. The rotation of the head body 4 is effected by a user actuating the input actuator 30 which may cause rotational torque to be transferred through a gear train to cause the head body 4 to rotate to expose unused blades.

The input actuator 30 may be located in the centre of a rotatable shaft 31. A user may rotate the input actuator 30 with a finger. The input actuator is fixed rigidly to the rotatable shaft 31. Preferably the input actuator 30 and the rotatable shaft 31 are moulded as a unitary item. The rotatable shaft 31 may be adapted to rotate inside circular slots moulded into the inside of the handle 2 housing. Alternatively the rotatable shaft 31 may be constrained in any other way provided it can rotate.

At the each end of the rotatable shaft there may be a primary gear 32 located thereon. The primary gears 32 are rigidly fixed to the rotatable shaft 31, preferably they are moulded unitary with the rotatable shaft 31. The primary gears 32 may be in operative engagement with an intermediate gear 33. The intermediate gear 33 may comprise of a receiving gear wheel 34 which receives rotation torque from the primary gear 32, and a transmitting gear 35 which transmits rotational torque to a final gear 36.

The receiving gear wheel 34 and the transmitting gear wheel 35 rotate about the same axis and are rigidly connected. Preferably they are moulded as a unitary item.

The receiving gear wheel 34 is preferably of the same pitch and diameter as the primary gear. Therefore there is preferably a 1:1 gear ratio between the primary gear 32 and the receiving gear wheel 34. Alternatively, the primary gear 32 and the receiving gear wheel 34 may be in any other suitable gear ratio.

The intermediate gear 33 (comprising the transmitting gear wheel 35 and the receiving gear wheel 34) is constrained to the handle 2. Preferably the intermediate gears 33 sit inside circular slots located inside the handle 2. The circular slots are preferably moulded with the handle 2.

The transmitting gear wheel 35 is preferably larger than the receiving gear wheel 34. The transmitting gear wheel may be operatively engaged with the final gear 36 which is fixed to the axle 5 of the head body 4. The final gear 36 may be located within the razor blade head housing 3. The gear ratio between the transmitting gear wheel 35 and the final gear 36 may be any suitable gear ratio.

Therefore, as rotational torque is transmitted to the final gear 36 from the transmitting gear wheel 35, the final gear 36 will rotate and cause the axle, and the head body 4 to rotate.

In use, a user would rotate the input actuator 30 with a finger, and that rotational torque is transmitted through the gear train to the axle 5, causing the head body 4 to rotate. Rotation of the head body 4 enables a new face with new blades 6 to be exposed for use in shaving.

A ratchet mechanism 40 may be located on the razor blade head 3 to ensure the head body 4 only rotates in one direction. Ensuring there is only one direction of rotation can be important, so that a user does not get confused as to what blades have already been used.

The ratchet mechanism 40 is preferably located on a clip 41 which can be pressed onto the head housing 3 so that the ratchet 40 is located within the head housing 4.

The ratchet mechanism 40 may have a pawl 42 which acts upon a gear 43. The gear 43 is preferably fixed to the end of the axle 5. The pawl may be biased by a spring or any other biasing means to ensure it rides over the edges of the gear 43, and thus only allows the gear 43 to be rotated in one direction. Alternatively, the pawl may be in engagement directly with the final gear 36, ensuring the final gear 36 (and the head body 4) is able to rotate in one direction.

The ratchet mechanism 40 may be located at one, or both ends of the head body 4.

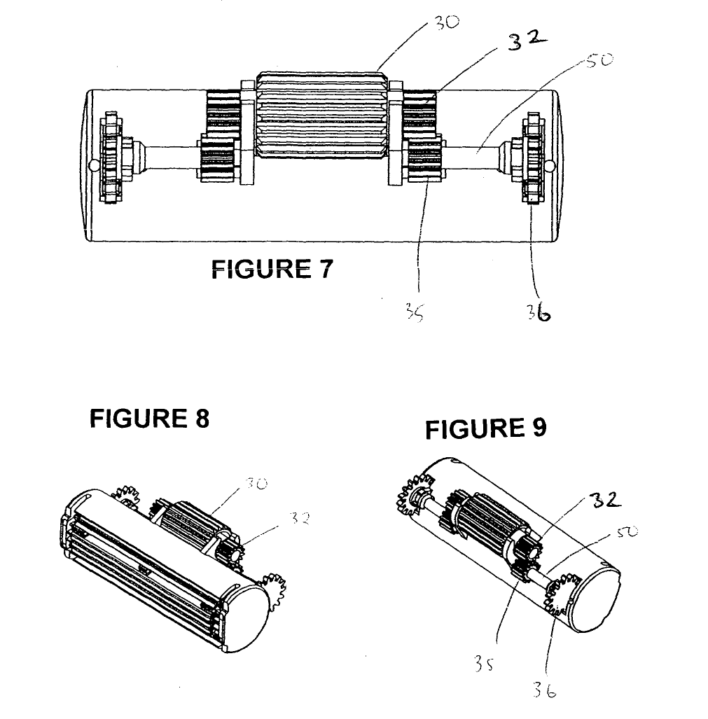

FIGS. 7 to 9 show an alternative gear train suitable for use in a razor of the present invention. The input actuator 30 is located at the centre of a rotatable shaft, however the rotatable shaft is shorter than the rotatable shaft 31 as shown in FIG. 1. Primary gears 32 may be located at either end of the rotatable shaft, on either side of the input actuator 30.

The gear train of FIGS. 7 to 9 operates in the same way as the gear train shown in FIG. 1, however as the primary gears 32 are located more centrally, the receiving gear 35 and the transmitting gear 36 are more spaced apart from one another. Preferably the receiving gear 35 and the transmitting gear 36 are connected via an axle 50 as shown in FIGS. 7 to 9.

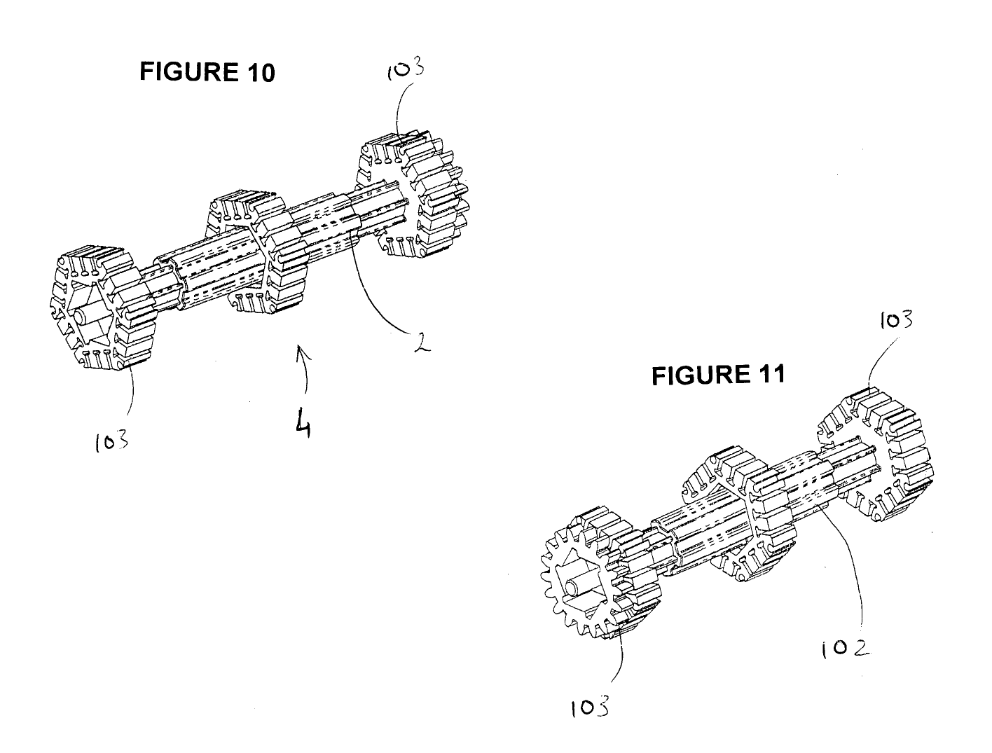

With reference to FIGS. 10 and 11 there is shown a shaver head body 4 that has a central axle or axle 102, and at least two hubs 103 extending from the axle 102. Preferably there are three hubs 103 extending from the axle 102. Each hub 103 may be any shape, and have any number of sides around its periphery.

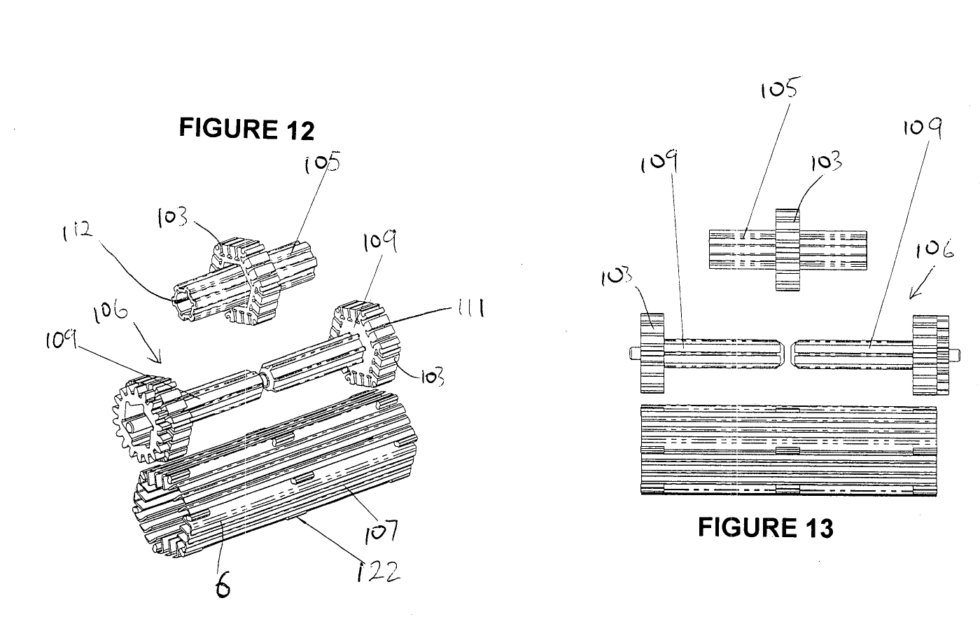

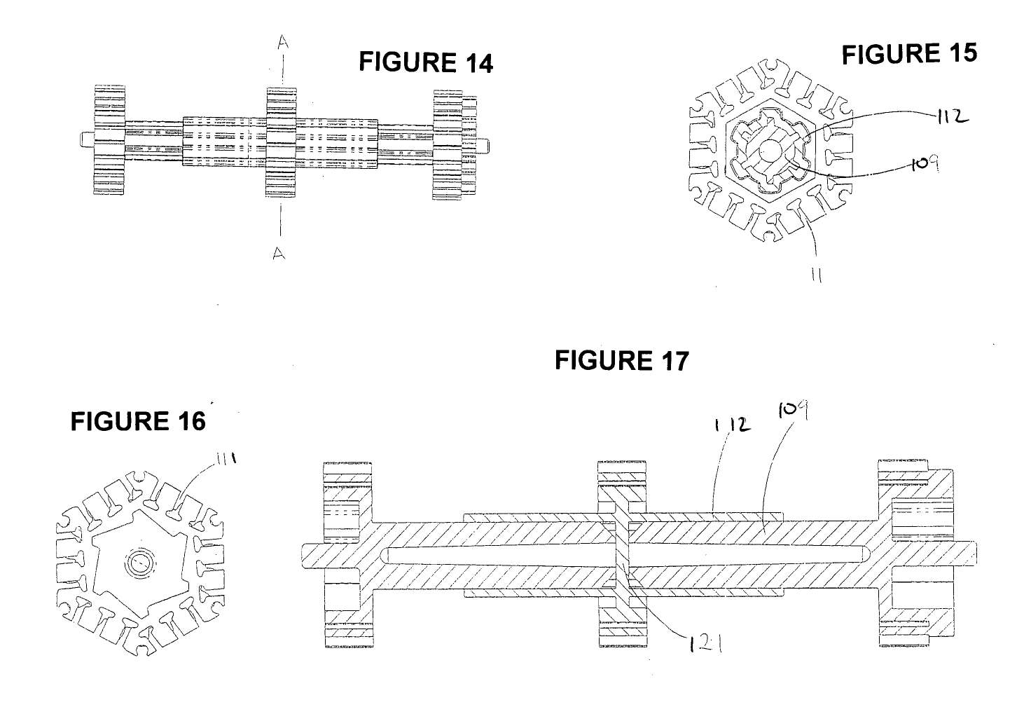

FIGS. 12 and 13 show exploded assembly views of a head body 4. The shaver head body 4 may comprise a central portion 105, two end portions 106, and a blade assembly 107. The assembly of the central portion and the two end portions may define the central axle 102 and the hubs 103 extending from the central axle 102.

Each end portion 106 may have a hub 103 located at the end of an elongate shaft 109. Alternatively the hub 103 may be located at any position on the elongate shaft 109. The hub 103 and the elongate shaft 109 are preferably moulded as a unitary item. Alternatively, the hub 103 and the elongate shaft 109 may be moulded separately and fixed together.

The central portion 105 may be used to connect the two end portions 106. The central portion 105 may be adapted to receive the elongate shafts 109 in its central bore 112. There may be a complementary relationship between the central bore 112 and the elongate shafts 109 of the end portions 106 to ensure they cannot rotate relative to one another. Preferably the central bore 112 and the elongate shafts 109 are in a splined engagement with one another. Alternatively, any other method of connecting the elongate shafts 109 with the central potion 105 may be used.

The central portion 105 may have a hub 103 extending from it. Preferably the central portion 105 has a hub 103 located substantially towards its centre. Preferably the hub 103 of the central portion is moulded unitary with the central portion. Alternatively, the hub 103 and the central portion may be moulded separately and fixed together.

It is preferred that the central portion 105 and the two end portions 106 may be moulded separately and then assembled together. Alternatively, the central portion 105 and the two end portions 106 may be moulded as a unitary item.

The blades 6 of the blade assembly 107 may be located in each recess 111 of the hubs 103. The blades may be inserted into the recesses 111 using any suitable method. The recesses 111 in each hub 103 ensure the blades are held rigidly, and parallel to the longitudinal direction of the head 4.

The manner in which the blades are mounted to the head body allows for multiple water passages to be established when flushing the head with water. No or a reduced number of cavities exist for debris for become trapped, even during water flushing. This facilitates the cleaning of the head.

FIG. 15 is a cross section through A-A. It shows the splined engagement of the elongate shaft 109 with the central bore 112. Each recess 111 for receiving a blade 6 is also shown. The hub 103 in FIG. 15 is hexagonal in shape. Therefore there are six sides in which blades 6 can be received. There are three recesses 111 on each side of the hub 103 for receiving three blades. Alternatively any number of blades may be located on each side of the hub 103.

FIG. 16 is an end view of the head body 4. The circular recesses in each corner of the hub 103 may be used to position wear strips 122. Wear strips 122 may indicate to a user that the head 4 should be rotated to expose a new set of blades for use. The wear strips 122 may for example change colour after a certain period of use, to indicate that a change is required. This may be achieved by providing a paint of a different colour over the base material that is positioned to be subjected to wear from the skin of the user. Over time the paint layer thins until the base layer becomes exposed.

FIG. 17 shows a cross section through B-B. It shows the location of the elongate shafts 109 inside the central bore 112. The end of the elongate shafts 9 may be abutted against an internal strip 121.

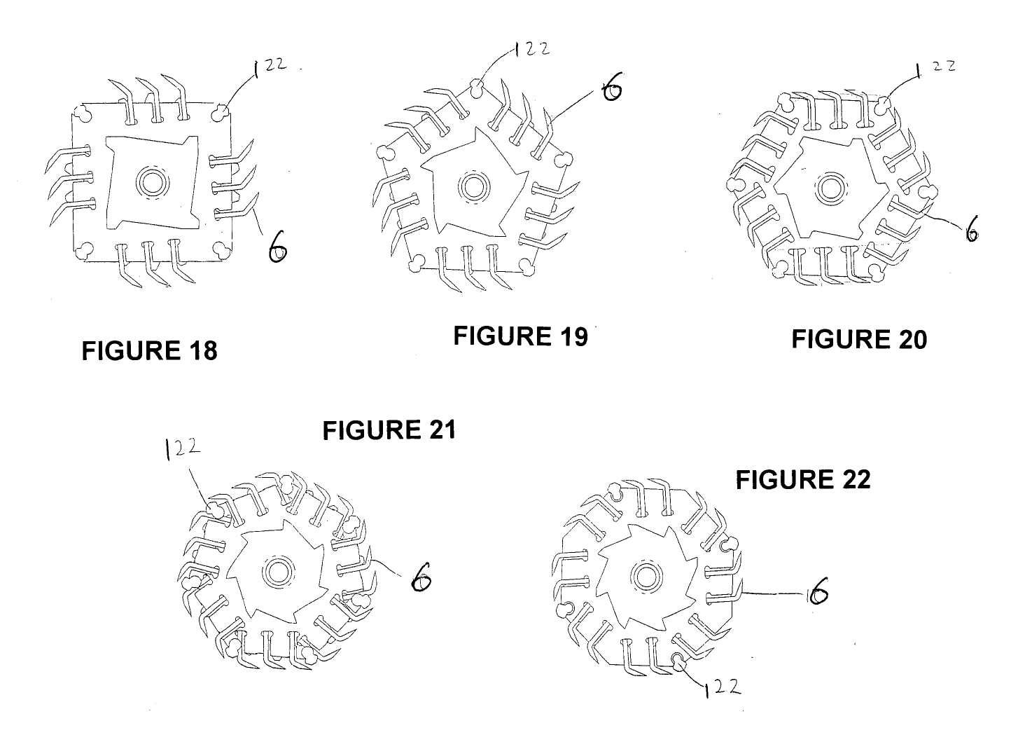

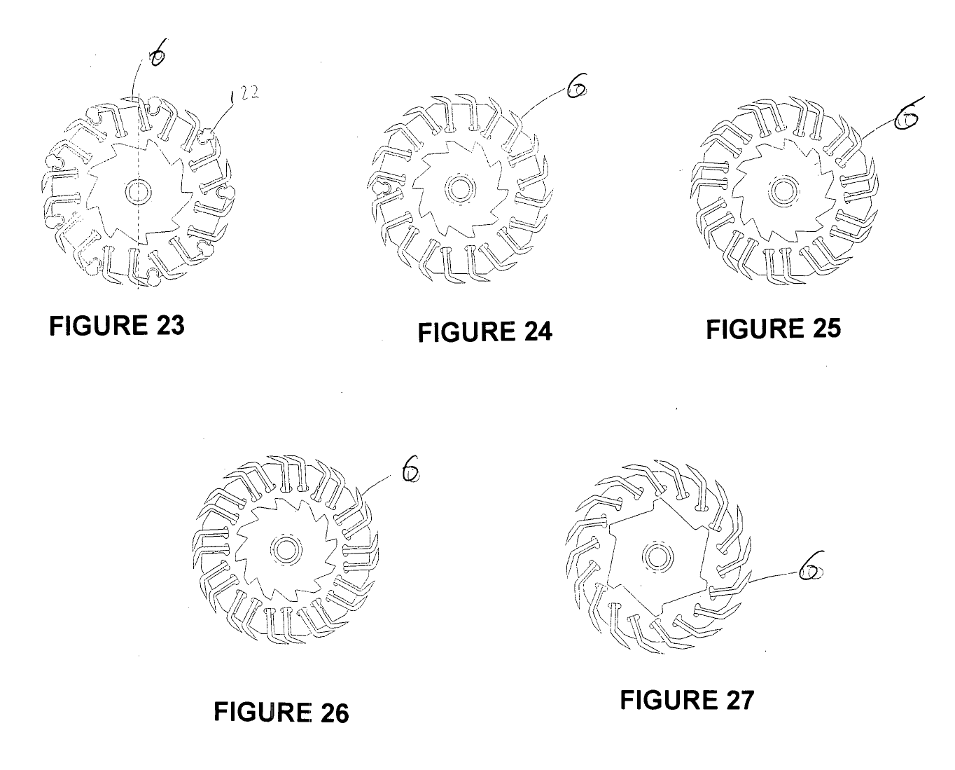

The hubs 103 which receive the blades 110 may have any number of sides. FIGS. 18 to 26 show end views of shaver heads that have hubs 103 with differing numbers of sides and differing numbers of blades 110 located thereon. Wear strips 122 may be located on the corners of each hub 103 as shown. FIGS. 18 to 26 show hubs 103 having four to twelve sides respectively.

FIG. 27 shows the end of a shaver head having a substantially round hub 103 with blades 6 located around its periphery.

1.-59. (canceled)

60. A manual razor comprising:
an elongate handle body,
a disposable razor blade head removably located substantially at one end of said handle body, said razor blade head comprising a rotatable head body and a plurality of elongate blades mounted from said head body in a manner to be rotational about an axis parallel to the elongate direction of the blades, wherein blades can be sequentially presented to present at least one of said blades in an operative manner for shaving,
an adjuster operatively engaged with said head body and including an input actuator located by said handle body to allow a digit of a user to actuate the rotation of the head body and plurality of elongate blades,
optionally wherein said input actuator is rotatably mounted relative said handle body.

61. A manual razor as claimed in claim 60 wherein said adjuster includes a gear train, wherein said gear train can transfer rotational torque (preferably in a mechanical advantaged manner) from said input actuator to said head body,
optionally wherein said input actuator is located substantially at the centre of a rotatable shaft mounted by said handle body,
optionally wherein said head body includes an axle.

62. A manual razor as claimed in claim 61 wherein said gear train comprises:
a primary gear located substantially by said rotatable shaft,
a final gear located by said axle,
a intermediate gear located between said primary gear and said final gear, said intermediate gear adapted to transfer rotation torque (preferably in a mechanical advantaged manner) from said primary gear to said final gear,
optionally wherein said primary gear is located substantially at an end of said rotatable shaft,
optionally wherein said final gear is located substantially at an end of said axle, and rigidly fixed to said axle,

63. A manual razor as claimed in claim 62 wherein said intermediate gear comprises a receiving gear wheel to receive said rotational torque from said primary gear, and a transmitting gear wheel to transmit said rotational torque to said final gear,
wherein said receiving gear wheel and said transmitting gear wheel are rotationally fixed relative to one another,
optionally wherein said receiving gear wheel and said transmitting gear wheel are connected together via an axle.

64. A manual razor as claimed in claim 60 wherein said razor blade head is coupled to said handle body by a retention means,
optionally wherein said retention means consists of at least one head retainer link.

65. A manual razor as claimed in claim 64 wherein said at least one head retainer link is located substantially at one end of said handle body,
optionally wherein said head retainer link can engage with a complementary part of said razor blade head, optionally wherein said head retainer link can engage in a snap-lock relationship with said razor blade head.

66. A manual razor as claimed in claim 60 wherein said razor blade head includes a ratchet mechanism provided to ensure said head body can only rotate in one direction about said rotational axis,
optionally wherein said ratchet mechanism includes a pawl in engagement with a gear, said gear being rigidly fixed to said axle, wherein said pawl constrains said gear to one direction of rotation,
optionally wherein said ratchet mechanism includes a pawl in engagement with said final gear wheel, said final gear wheel being rigidly fixed to said axle, wherein said pawl constrains said final gear wheel to one direction of rotation.

67. A manual razor as claimed in claim 60 wherein said head body has at least three face sides, wherein at least one of said elongate blades are mounted to each said face side,
optionally wherein a plurality of said elongate blades are mounted to each said face side of said head body,
optionally wherein said disposable razor blade head includes a housing that mounts and substantially houses said head body,
optionally wherein said head body comprises: an axle, at least two spaced apart hubs extending from said axle, wherein each hub mounts said plurality of elongate blades such that the blades are mounted in a manner to each extend, in their elongate direction, parallel to each other and parallel to the axle.

68. A manual razor as claimed in claim 67 wherein the blades do not contact the central axle and are positioned spaced away from the central axle to facilitate a cleaning of the blades by water that can circulate between the blades and the axle,
optionally wherein the blades are supported by each of the hubs only,
optionally wherein the blades are mounted to not contact each other.

69. A manual razor as claimed in claim 67 wherein the axle comprises of multiple parts each part including one of the hubs, wherein each axle part can engage with (and preferably to) the other axle parts to form a central axle assembly,
optionally wherein each blade includes a straight cutting edge parallel to the elongate direction.

70. A disposable razor blade head for removable engagement to an elongate handle that includes an input actuator, said razor blade head comprising
a head body rotatable relative to said handle,
a plurality of elongate blades mounted from said head body in a manner to be rotational with said head body about an axis parallel to the elongate direction of the blades, wherein blades can be sequentially presented to present at least one of said blades in an operative manner for shaving,
a gear operatively engaged with said head body and capable of becoming operatively engaged with said input actuator that allows a digit of a user to actuate the rotation of the head body and plurality of elongate blades,
optionally wherein said head body includes an axle.

71. A disposable razor blade head as claimed in claim 70 wherein said gear is located by said axle, and is presented to be able to operatively engage with said input actuator,
optionally wherein said gear is located substantially at an end of said axle, and rigidly fixed to said axle.

72. A disposable razor blade head as claimed in claim 70 wherein said razor blade head includes a mount that is able to releasably couple to said handle by a retention means,
optionally wherein said retention means consists of at least one head retainer link,
optionally wherein said at least one head retainer link is located substantially at one end of said handle,

73. A disposable razor blade head as claimed in claim 72 wherein said mount can engage with a complementary part of the head retainer link,
optionally wherein said mount can engage in a snap-lock relationship with said head retainer link.

74. A disposable razor blade head as claimed in claim 70 wherein said razor blade head includes a ratchet mechanism provided to ensure said head body can only rotate in one direction about said rotational axis,
optionally wherein said ratchet mechanism includes a pawl in engagement with a gear, said gear being rigidly fixed to said axle, wherein said pawl constrains said gear to one direction of rotation.

75. A disposable razor blade head as claimed in claim 74 wherein said ratchet mechanism includes a pawl in engagement with said gear, said gear being rigidly fixed to said axle,
wherein said pawl constrains said gear to one direction of rotation.

76. A disposable razor blade head as claimed in claim 70 wherein said head body has at least three face sides, wherein at least one of said elongate blades are mounted to each said face side,
optionally wherein a plurality of said elongate blades are mounted to each said face side of said head body.

77. A disposable razor blade head as claimed in claim 70 wherein said disposable razor blade head includes a housing that mounts and substantially houses said head body,
optionally wherein the head body comprises: an axle, at least two spaced apart hubs extending from said axle, wherein each hub mounts said plurality of elongate blades such that the blades are mounted in a manner to each extend, in their elongate direction, parallel to each other and parallel to the axle,
optionally wherein the blades do not contact the central axle and are positioned spaced away from the central axle to facilitate a cleaning of the blades by water that can circulate between the blades and the axle.

78. A disposable razor blade head as claimed in claim 77 wherein the blades are supported by each of the hubs only,
optionally wherein the blades are mounted to not contact each other.

79. A disposable razor blade head as claimed in claim 77 wherein the axle comprises of multiple parts each part including one of die hubs, wherein each axle part can engage with (and preferably to) the other axle parts to form a central axle assembly,
optionally wherein each blade includes a straight cutting edge parallel to the elongate direction.
